(19) United States
(12) Patent Application Publication
(10) Pub. No.: US 2006/0184989 A1
(43) Pub. Date: Aug. 17, 2006

(54) Interacting with Internet applications via a broadband network on electronic input/output devices

(75) Inventor: Louis Paul Slothouber, Leesburg, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: BIAP Systems, Inc., Dulles, VA (US)

(21) Appl. No.: 11/350,923

(22) Filed: Feb. 10, 2006

Related U.S. Application Data
(60) Provisional application No. 60/651,665, filed on Feb. 11, 2005.

(51) Int. Cl. H04N 7/173

(52) U.S. Cl. 725/110; 725/109; 725/112

(57) ABSTRACT

A system and method for interacting with internet applications by way of a broadband network that includes one, or a combination, of cable television, satellite television, internet protocol television, cellular network, or digital subscriber line network. The system and method allow a user to execute at an end user device, e.g., a television or cellular phone, an interactive application associated with an internet-based service, such as an online auction, online commercial transaction, online gaming, or an information service, e.g., yellow pages on TV, and initiate a user interface by which the user formulates and transmits action requests and receives action replies or unsolicited messages via the broadband network allowing the user to locally interact with one or more of the internet-based services.

### CROSS-REFERENCE TO RELATED APPLICATION

This application claims the benefit of prior U.S. Provisional Application Ser. No. 60/651,665, filed Feb. 11, 2005 and entitled “INTERACTING WITH INTERNET APPLICATIONS VIA A BROADBAND NETWORK ON ELECTRONIC INPUT/OUTPUT DEVICES” which is incorporated herein in its entirety.

### FIELD OF THE INVENTION

The present invention relates to telecommunications, and more particularly, to a system and method for interacting with Internet applications via a broadband network on electronic input/output devices such as digital cable, satellite, and Internet Protocol (IP) television set-top boxes.

### BACKGROUND OF THE INVENTION

Over the past few years, the television industry has gone through a number of significant transformations in the way by which television programming is distributed to consumers. Terrestrial television (also known as over-the-air, OTA, or broadcast television) is the traditional method of television broadcast signal delivery by radio waves transmitted freely through space. Although the signal quality was not great, nevertheless, it was for a number of years the prominent method of delivering television programming. Nowadays, customers have a variety of options to subscribe to broadcast television programming, such as satellite, direct broadcast satellite (DBS) systems, cable television or community antenna television (CATV) systems, TV over internet (IPTV), and multichannel multipoint distribution service (MMDS).

Because of the popularity of the Internet, computer users are getting online to search for and download their choice of information from the large amount of information content already available. These days, computer users are able to do a myriad of electronic commerce activities, including purchasing items online, receiving and paying bills, banking, creating on-line personal profiles, placing items for auctioning, bidding on auctioned items, playing games, acquiring weather information, creating and managing fantasy sports teams, taking classes online, and a large number of interactive activities.

Comparatively, broadcast television technology has been developing interactive television since 1953 with the introduction of a children's show by the name of “Winky Dink and You” where the children helped a character named Winky Dink get out of a jam by placing a plastic sheet over the TV screen to draw a rope, a ladder, bridge etc., to help Winky Dink cross a river, for example. Ever since the advent of that simple television interactive program, service providers have offered one form or another of interactive programming, such as interactive program guides (IPGs) that allow the viewer to interactively select their television programming WebTV, a dial-up service that provides users with internet access using the television as a display, personal video recorders, such as TiVo and ReplayTV, that allow users to capture and save television programs into a hard disk for later viewing, and video on demand, which allows users to download movies, games or other programs onto a set-box for viewing at anytime.

Unlike the internet, television for many is a primary source of global news, entertainment, product and cultural knowledge. And the internet facilitates a wide range of interactive applications. Countless prior art attempts to use television in accessing the internet in one form or another have many shortcomings. For example, U.S. Pat. No. 6,772,394 to Kamada proposes a redesigned television set with added internal internet circuitry including a connector that facilitates internet connection. Other attempts include a television that displays two modes, an interactive application mode and a television program mode, and means for switching between these two modes.

Unfortunately, the interactive television systems in existence today are somewhat limited in that total interactivity using the television medium to interact with web sites in a timely fashion is non-existent.

### SUMMARY OF THE INVENTION

In view of the deficiencies of the prior art, it is an object of the present invention to provide a system and method that will allow television viewers to interact with online web sites via their television sets.

In an embodiment of the invention, a method for interacting with Internet applications via a broadband network comprises the steps of: executing an interactive application associated with an Internet-based service; generating a user interface for the interactive application for display on a display device; receiving a user selection via the user interface; transmitting a request over a broadband network to a centralized server coupled to the broadband network, wherein the request comprises information associated with the user selection; receiving a reply over the broadband network to the request, wherein the reply comprises information associated with the Internet-based service and in response to the request; and processing the reply for display on the display device. The Internet-based service is an online auction, an online store, or an information service. The broadband network is selected from the group consisting of: cable television network, satellite television network, IPTV network, cellular network, a digital subscriber line, and a combination thereof. In a related embodiment of the invention, the broadband network is a hybrid fiber-coax cable television network, the display device is a television, the request is transmitted on an upstream channel of the cable television network, the user selection is received from a remote control, and the reply is received via a downstream channel of the cable television network. The Internet-based service is hosted by one or more servers accessible through the Internet.

In another embodiment of the invention, a method for interacting with Internet applications via a broadband network comprises the steps of: receiving a first request for information associated with an Internet-based service from an end user device coupled to a broadband network; converting the first request into a second request, wherein the second request is directed to a server accessible through the Internet hosting the Internet-based service; receiving a first reply from the server; and converting the first reply into a second reply for transmission over the broadband network to the end user device. The first request comprises information associated with a user selection formulated through a user interface provided at the end user device. The first reply comprises information associated with the Internet-based service and in response to the second request. The Internet-based service is an online auction, online store, or an information service. The broadband network is selected from the group consisting of: cable television network, satellite television network, IPTV network, cellular network, a digital subscriber line, and a combination thereof. In a related embodiment of the invention, the broadband network is a hybrid fiber-coax cable television network, the steps of receiving are performed at a device coupled to the cable television network and the Internet, the first request is received on an upstream channel of the cable television network, the transmission occurs via a downstream channel of the cable television network, and the end user device is a cable television set-top box.

In another embodiment of the invention, a method for interacting with Internet applications via a broadband network comprises the steps of: executing an interactive application associated with an Internet-based service; generating a user interface for the interactive application for display on a display device; receiving a broadcast over the broadband network, wherein the broadcast comprises data made available by the Internet-based service; and processing the broadcast data by a centralized server that receives the data, and transmits it for display on the display device. The method can further comprise the step of receiving one or more user preferences selected via the user interface, and wherein the step of processing comprises the step of filtering the broadcast according to the one or more user preferences. The Internet-based service is a fantasy sports data providing service, a weather data providing service, or a financial data providing service, as well as any information providing service. The broadband network is selected from the group consisting of: cable television network, satellite television network, IPTV network, cellular network, a digital subscriber line, and a combination thereof. In a related embodiment of the invention, the broadband network is a hybrid fiber-coax cable television network, the display device is a television, the broadcast is received via a downstream channel of the cable television network, and the Internet-based service is hosted by one or more servers accessible through the Internet.

In another embodiment of the invention, a method for interacting with Internet applications via a broadband network comprises the steps of: receiving first information made available by the Internet-based service; and converting the first information into second information by a centralized server to be broadcast over a broadband network to one or more end user devices, wherein the broadband network is a digital television network and the one or more end user devices are digital television set-top boxes. The Internet-based service is a fantasy sports data providing service, a weather data providing service, or a financial data providing service.

In another embodiment of the invention, a system comprises: a server coupled to the Internet and coupled to a backend gateway of a broadband network; and one or more end user devices coupled to the broadband network, wherein the server acquires data made available by at least one source accessible through the Internet, and converts the data into a format for transmission over the broadband network by the backend gateway to the one or more end user devices. The source may comprise an online store, an online auction facilitator, a fantasy sports data provider, a news source, a search engine, an instant messaging source, or an information source provider. The broadband network is selected from the group consisting of: a digital cable TV network, a digital satellite TV network, a digital cell phone network, a digital telephone network, and a combination thereof. The at least one of the one or more end user devices comprises a first component that is selected from the group consisting of: a digital cable TV set-top box, a digital satellite TV set-top box, an IPTV set-top box, a game console, a digital cell phone, a PDA, or a combination thereof.

In another embodiment of the invention, a method comprises the steps of: generating a user interface on an electronic input/output device; and executing Internet commerce via a broadband network on the electronic input/output device. The Internet commerce is an Internet-based auction, an Internet-based online retail transaction, or any other electronic commerce transaction. The method can further comprise the step of displaying targeted, local advertising on the electronic input/output device. The step of executing Internet commerce can further comprise the step of tendering payment.

In an embodiment of the invention, a method comprises the steps of: routing at least one Internet-based alert message through a television network and displaying the at least one Internet-based alert message on an electronic input/output device. The Internet-based alert is a spontaneous message or notification transmitted via the Internet network for display on a personal computer. In a related embodiment of the invention, the alert is a notification for an online auction.

In another embodiment of the invention, a method comprises the steps of: generating a user interface at a digital television set-top box for an Internet auction, displaying the user interface on a display coupled to the digital television set-top box, and placing an auction bid on the Internet auction using a remote-control coupled to the digital television set-top box. The remote control can comprise up and down arrows to increase and decrease, respectively, the amount of the auction bid and/or keys mapped to pre-defined bid amounts. The method may further comprise the step of providing auction feedback comments from a pre-defined list of frequently used comments mapped to keys on the remote-control or from a large, pre-defined list of standard comments selectable via up and down keys on the remote control. Payment and shipping information can be automatically provided to the Internet auction after a successful purchase or auction bid.

In another embodiment of the invention, a method comprises the steps of: receiving an alert message from an Internet source; translating the alert message to a standard format; routing and transmitting the alert message to an end user device on a broadband network; displaying the alert message on the end user device; capturing a user response to the alert message; and processing the user response. The end user device comprises a digital television set-top box. The step of processing comprises the step of: executing an interactive application on the digital television set-top box, or forwarding the user response back to the Internet source.

The foregoing, and other features and advantages of the invention, will be apparent from the following, more particular description of the embodiments of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is an interactive communications system according to an embodiment of the invention;

FIG. 2 illustrates a flow diagram of an interactive communications process according to an embodiment of the invention;

FIG. 3 is a flow diagram of an interactive communications process according to an embodiment of the invention;

FIG. 4 illustrates an interactive television system according to an embodiment of the invention;

FIGS. 5(a)-5(i) are screen shots illustrating a fantasy sports application according to an embodiment of the present invention;

FIG. 6(a)-6(d) are screen-shot illustrations of an interactive application according to an embodiment of the present invention;

FIGS. 7(a)-7(d) are graphical user interface illustrations according to an embodiment of the present invention;

FIGS. 8(a)-8(d) are graphical user interface illustrations according to an embodiment of the present invention; and

FIG. 9 depicts an interactive voting graphical user interface according to an embodiment of the present invention.

### DETAILED DESCRIPTION OF THE EMBODIMENTS

Embodiments of the present invention and their advantages may be understood by referring to the figures, wherein like reference numerals refer to like elements, and are described in the context of a broadband network facilitating interaction between electronic input/output end user devices and various Internet applications operating at one or more nodes on the Internet.

The term “Internet applications” includes all Internet and intranet Web sites, whether public or private, and Web-based applications such as, but not limited to online auctions at, for example, eBay™ or uBid™; online stores at, for example, Amazon™ and WalMart™ and others; fantasy sports games at, for example, Yahoo™; dating services at, for example, Yahoo™; American Online (AOL)™ Instant Messaging; AOL Alerts; news services at, for example, CNN™; and search engines at, for example, Google™.

The term “electronic input/output devices” refers to all end user devices coupled to a broadband network, by either free access or subscription, that facilitate user interaction and display of downstream data and/or video transmission. Electronic input/output devices include, but are not limited to digital cable television (TV) set-top boxes, e.g., Motorola's DCT-2000, Scientific-Atlanta's (SA) Explorer, and the like; digital satellite TV set-top boxes, e.g., DirecTV or DISH network receivers, and the like; Internet Protocol (IP) TV (IPTV) set-top boxes, e.g., receivers provided by companies such as SBC, Verizon, Motorola, Amino etc.; networked game consoles, e.g., Sony PlayStation II, Microsoft Xbox, and the like; and/or digital cell phones or Personal Digital Assistants (PDAs), and the like. Additional examples include digital video recorders (DVRs), e.g., TiVo, Sling and other so-called “sidecar” boxes that operate in conjunction with a cable or satellite receiver, and other network ready digital television equipment, e.g., OpenCable Applications Platform (OCAP) devices and Quadrature Amplitude Modulated (QAM) receivers.

Cable, satellite, and IPTV set-top boxes are coupled to a television for display output and a remote control, keypad, or keyboard for user input. Game consoles are also coupled to a television for display output and to a game controller, remote control, keypad, or keyboard for user input. Cell phones and PDAs are usually equipped with an embedded display, such as a liquid crystal display (LCD) for output, and a keypad or stylus and touch-screen for user input. The above electronic input/output devices are exemplary only. One of ordinary skill in the art recognizes that other types of interactive communication devices can be used, as well as various other output and/or input means, e.g., mouse, joystick, or voice recognition.

The term “broadband network” refers to any type of network which carries bi-directional transmissions between networked stations. Exemplary broadband networks include digital cable television facilitated by a hybrid fiber-coax (HFC) network implementing Data Over Cable Service Interface Specification (DOCSIS), digital television not facilitated by DOCSIS, digital satellite TV networks, digital cellular networks, Digital Subscriber Lines (DSL), and IPTV, the implementation of which are apparent to one of ordinary skill in the art. A broadband network can also comprise a combination of the above examples. In certain embodiments of the invention, the broadband network comprises a Moving Picture Experts Group (MPEG) standard video stream for downstream data and another path, e.g., Public Switched Telephone Network (PSTN) line, for upstream data.

As will be described in greater detail, the present invention provides end users the ability to conduct Internet commerce over conventional broadband networks, such as a cable television network, that have previously been unable to facilitate such an operation. “Internet commerce” includes, but is not limited to, any type of online sale (e.g., the search and display of goods and services for sale), online targeted advertising (e.g., overlaying a targeted advertisement on top of video or interactive applications, where the targeted advertisement is chosen individually, based on some criteria, for each viewer) financial transactions (e.g., the purchase and payment for a good or service), and auction sales (e.g., eBay). At least one of the following embodiments is described in the context of allowing users of cable television set-top boxes to interact with an Internet auction.

Certain embodiments of the present invention also facilitates the routing of Internet-based alerts, i.e., alert messages generated at a Web site on the Internet, through a conventional broadband network and displays them on a television coupled to an end user device such as a cable television set-top box. Such an “Internet-based alert” includes, but is not limited to any type of spontaneous or triggered message and notification normally transmitted via an Internet network and displayed on personal computers or cell phones, for example, an eBay outbid notification via email or an AOL stock alert by implementing Short Message Service (SMS). Such alerts are capable of launching other interactive applications on the set-top box and may generate a response to send back to the source of the alert on the Internet.

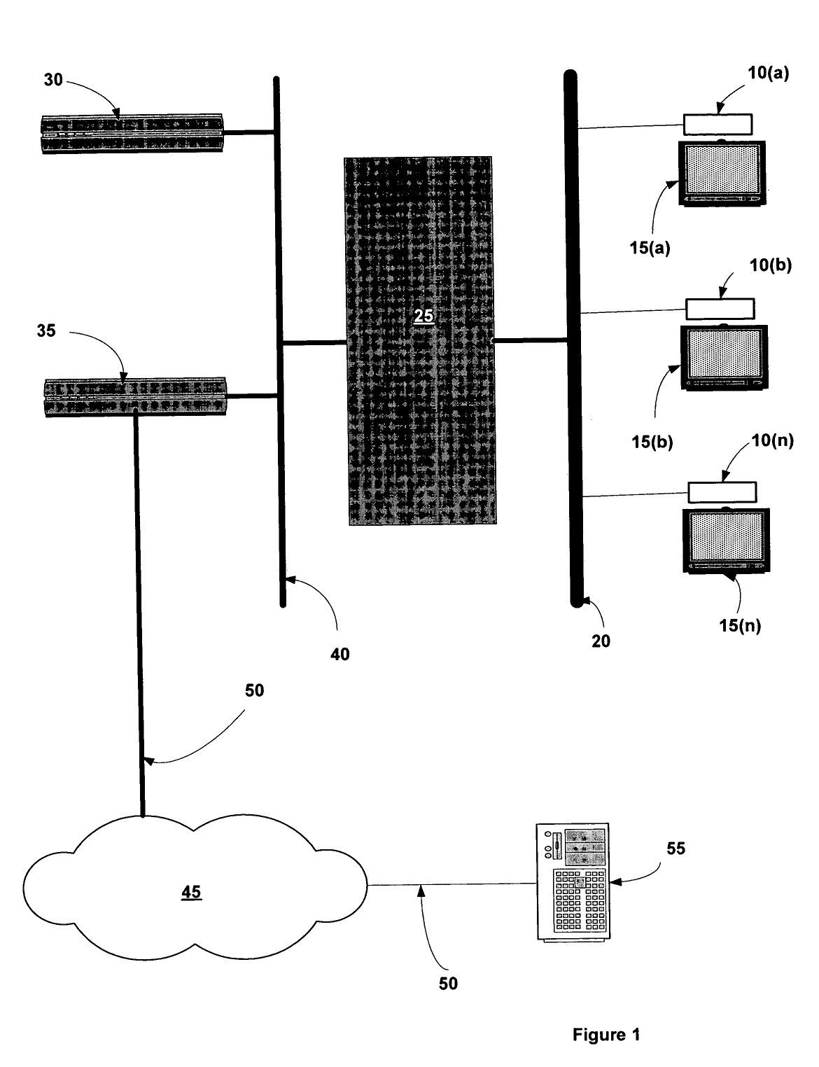

FIG. 1 illustrates an interactive communications system 100 according to an embodiment of the invention. The interactive communications system 100 comprises one or more end user devices 10(a)-10(n) and displays 15(a)-15(n) coupled thereto, a broadband network 20, a backend gateway 25, an in-band data carousel 30, a centralized server 35, and a communications network 40 implementing, for example, a protocol such as Transmission Control Protocol (TCP) or User Datagram Protocol (UDP). The centralized server 35 is coupled to one or more Web site servers 55 (only one is shown) via the Internet 45 and Internet connections 50; the implementation of such connections are apparent to one of ordinary skill in the art.

As noted above, the end user device 10(a)-10(n) is a digital cable, digital satellite, or IPTV set-top box, or a networked game console or a digital cell phone/PDA. Typically, the end user device 10(a)-10(n) is required to pay a subscription fee to the operator of the broadband network 20 in order to receive broadband services, e.g., television programming, and/or interactive applications such as those described below. In the scenario where the broadband network 20 is a cable television network, the end user device 10(a)-10(n) comprises a TV tuner, the implementation of which is apparent to one of ordinary skill in the art, that demodulates the television signal and then converts it into a digital signal, which is then decoded by a hardware-based decoder (e.g., MPEG-2, MPEG-4) into an appropriate signal for display on the end user display 15(a)-15(n). The end user device 10(a)-10(n) further includes or is coupled to a means for allowing a user of the end user device 10(a)-10(n) to input information, commands, requests, etc. (i.e., interact with the interactive applications running on the end user device 10(a)-10(n)). Such an input means may come in the form of a remote control, a keyboard, keypad, or other data entry or menu driven device. The end user device 10(a)-10(n) further comprises one or more processors, and/or any other device that interprets and executes instructions in order to implement one or more of the interactive software applications described herein.

The broadband network 20 may be any type of communications network that can connect the end user device 10(a)-10(n) and end user display 15(a)-15(n) to the backend gateway 25. As noted above, the broadband network can comprise a HFC distribution network, DSL, a cellular network, a satellite network, a computer network, or a combination thereof, e.g., a DirecTV system wherein a satellite medium is used for downstream communications and a telephone line is used for upstream communications.

In an embodiment of the invention where the broadband network 20 is a cable television network, the backend gateway 25 may be a cable headend, i.e., a cable television company's local facility, which originates and communicates cable TV programming and/or services to its subscribers having the set-top boxes 10(a)-10(n). The cable headend 25 also facilitates upstream communications from the end user device 10(a)-10(n) to the centralized server 35 on an upstream channel, the implementation of which is apparent to one of ordinary skill in the art, separate from the downstream channel(s). All downstream channels—video or data—are combined into a single signal at the cable headend 25, the implementation of which is apparent to one of ordinary skill in the art. In an embodiment of the invention, the cable headend 25 combines data from the in-band carousel 30 and/or the centralized server 35, and video from one or more sources (not shown) into a single signal that is transmitted to the end user device 10(a)-10(n) over the broadband network 20. The user of the end user device 10(a)-10(n) generally controls what is displayed on the end user display 15(a)-15(n).

In an embodiment of the invention where the broadband network 20 is a satellite network, the backend gateway 25 may be the satellite company's headend that facilitates downstream delivery of television and data to the end user device 10(a)-10(n). To facilitate upstream communication from the end user device, the satellite headend comprises an appropriate modem for communicating with the end user device 10(a)-10(n) over a non-satellite transmission medium such as a PSTN line.

In an embodiment of the invention where the broadband network 20 is a cellular network, the backend gateway 25 may be a Web gateway coupled to the cellular network. The Web gateway 25, the implementation of which is apparent to one of ordinary skill in the art, acts as an exchange between the cellular communications facilitated on the cellular network and those communications, e.g., Transmission Control Protocol/Internet Protocol (TCP/IP) messages, facilitated on the communications network 40 and/or Internet 45. The Web gateway 25 may also support a Wireless Application Protocol (WAP) and/or SMS messaging.

Regardless of the type of broadband network 20 employed, a standard and off-the-shelf backend gateway 25 appropriate for that type of network may be used. No modification of the broadband network 20 and backend gateway 25 is necessary to facilitate the interactive applications described herein.

The in-band data carousel 30 may be a standard off-the-shelf data carousel that is implemented to pump (broadcast) certain data to the end user devices 10(a)-10(n). For instance, the in-band data carousel 30 may comprise hardware and software that repeatedly and continually broadcasts on the broadband network 20 a set of files or other data, which is typically useful to a number of end user devices 10(a)-10(n) on the broadband network 20. In at least one embodiment of the invention, the in-band data carousel 30 is modified to serve as a first in, first out (FIFO) queue, in which data is broadcast downstream to the end user devices 10(a)-10(n) in the same order in which it is added from the centralized server 35. The centralized server 35 can be a standard off-the-shelf server that facilitates communication with the one or more Internet servers 55. In another embodiment of the invention, the in-band data carousel 30 is modified to serve as a dynamic in-band HTTP gateway, relaying HTTP response data from the centralized server 35 to the end user devices 10(a)-10(n) in a single, non-repeated broadcast.

In a cable television environment, the digital data originating from the in-band carousel 30 and/or the centralized server 35 is broadcast from the backend gateway 25, i.e., cable headend, to the end user devices 10(a)-10(n) on a given frequency or channel. In an embodiment of the invention, that data is a stream of MPEG encoded video. In another embodiment of the invention, the data is a stream of any other, non-video data. Alternatively, non-video data can be embedded in the “I-frames” of an MPEG stream, the implementation of which is apparent to one of ordinary skill in the art. In some embodiments of the invention, the MPEG stream may be further encoded to encrypt the stream for copy protection purposes or to facilitate transmission, e.g., Motorola DC-2 format. In a broader sense, the broadcast transmission format can be any type of format as long as the backend gateway 25 and end user devices 10(a)-10(n) implement the same data format.

In the case of the in-band data carousel 30, non-video data is typically broadcast by backend gateway 25 in the form of one or more conventional files embedded within an MPEG stream. These files are broadcast in a continuous circular rotation, one after another forever or until removed from the carousel. In some carousels special files describe organization of the files into a “virtual” file system—i.e., volumes/disks and directories/folders, so that files may be accessed via a Uniform Resource Locator (URL) or path name as if they lived on a physical storage device (called a Broadcast File System or BFS). On the cable set-top box 10(a)-10(n), software (sometimes hardware) may tune in to the channel/frequency of the carousel and grabs copies of requested file(s) as they “go by.” Different amounts of bandwidth can be assigned to each in-band channel, so a video channel can be high-definition (e.g., 18 Mbps), high-quality (e.g., 6 Mbps) or low quality (e.g., 1 Mbps).

Most conventional set-top boxes have only one “in-band” tuner (although newer, TiVo-like DVR boxes sometimes have multiple tuners). Typically, if the software is going to retrieve data from the in-band carousel 30 it has to “tune away” from a video channel to do it. To avoid this and allow downstream communication while video is being displayed, the set-top box 10(a)-10(n) comprises a second tuner that may always be tuned to a single, low-bandwidth channel. It can access data on this “out-of-band” channel anytime. The data carousel 30 or a separate low slow-speed carousel could transmit on this out-of-band channel. All this may be just for downstream traffic, from the headend 25 to the set-top box 10(a)-10(n). For upstream traffic back up to the headend 25 another, low-bandwidth, out-of-band mechanism may be used, the identification and implementation of which is apparent to one of ordinary skill in the art.

The in-band carousel 30 and centralized server 35 are coupled to one another and the backend gateway 25 through the communications network 40. The communications network 40 can be any type of network, the identification and implementation of which is apparent to one of ordinary skill in the art, which facilitates communication between these network nodes. In an embodiment of the invention, the communications network 40 is an IP network and backend gateway 25, in-band carousel 30, and centralized server 35 are each identified by a unique IP address, the implementation of which is apparent to one of ordinary skill in the art.

In an embodiment of the invention, all of the hardware components of the interactive communications system 100 are standard off-the-shelf components, perhaps augmented by off-the shelf hardware cards, e.g., an MPEG encoder and video pump card with a standard PCI slot interface, to provide additional capabilities. The end user device 10(a)-10(n), in-band carousel 30 and centralized server 35 are provided with and execute the novel software that collectively implements the interactive applications described herein. In an embodiment of the invention, interactive applications primarily reside within and are executed by the end-user device 10(a)-10(n), and both the in-band carousel 30 and the centralized server 35 provide services to support those applications.

In an embodiment of the invention, the interactive applications are software applications individually tailored for a certain set of tasks, to interact with a certain type of Web site, and/or to provide a certain type of Internet-based service to the user of the end user device 10(a)-10(n). For example, a first interactive application allows a user of the end user device 10(a)-10(n) to interact with auctions at eBay.com, a second interactive application allows the user to monitor fantasy sports results at Yahoo.com or any other fantasy sports provider (e.g., FanBall.com), a third interactive application allows the user to purchase items from an online store, e.g., at Amazon.com, and a fourth interactive application allows the user to find information and advertising relating to local businesses by interacting with an appropriate provider of such information, e.g., Yellow Pages.

One of ordinary skill in the art recognizes that the number and types of interactive applications that could be provided are relatively endless, being only limited by the number and types of services provided via the Internet. Certain embodiments of the present invention bring user-chosen internet Web sites and services to television via TV-appropriate interfaces. The present invention is not restricted to simply rendering web pages on TV. In addition, certain embodiment of the present invention include the ability to manage bandwidth, route out-of-band data into an inband channel and vice-a-versa, fit the received data on the screen, render colors on TV, and interact with internet applications associated with those web site using a conventional remote-control.

In a broad sense, embodiments of the present invention bring the Web and the ability to interact therewith to end users via a conventional broadband network and end user devices.

At this point it should be noted that the interactive applications in accordance with the present invention involve the processing of input data and the generation of output data. This input data processing and output data generation may be implemented in hardware and/or software. For example, specific electronic components may be employed in an integrated circuit, chipset, or similar or related circuitry for implementing the functions associated with the interactive application processing steps as described below. Alternatively, one or more processors operating in accordance with stored instructions may implement these steps in accordance with the present invention as described herein. If such is the case, it is within the scope of the present invention that such instructions may be stored in local storage of the end user device 10(a)-10(n) and/or the centralized server 35, on one or more processor readable carriers (e.g., a magnetic disk, smart card, or CD-ROM), or transmitted (i.e., downloaded) to one or more processors in the end user device 10(a)-10(n) and/or the centralized server 35 via one or more signals originating externally.

The following describes two interactive communications processes for facilitating end user device 10(a)-10(n) interaction with one or more Web site servers 55 via the broadband network 20 and backend gateway 25. The first interactive communication process is described in the context of an interactive application that allows a user of the end user device 10(a)-10(n) to interact with online auctions. The second interactive communication process is described in the context of an interactive application that allows a user of the end user device 10(a)-10(n) to interact with fantasy sports data provided by a fantasy sports Web site. In at least one embodiment of the invention, the interactive application comprises two software components, one of which executes at the end user device 10(a)-10(n) and the other of which executes at the centralized server 35.

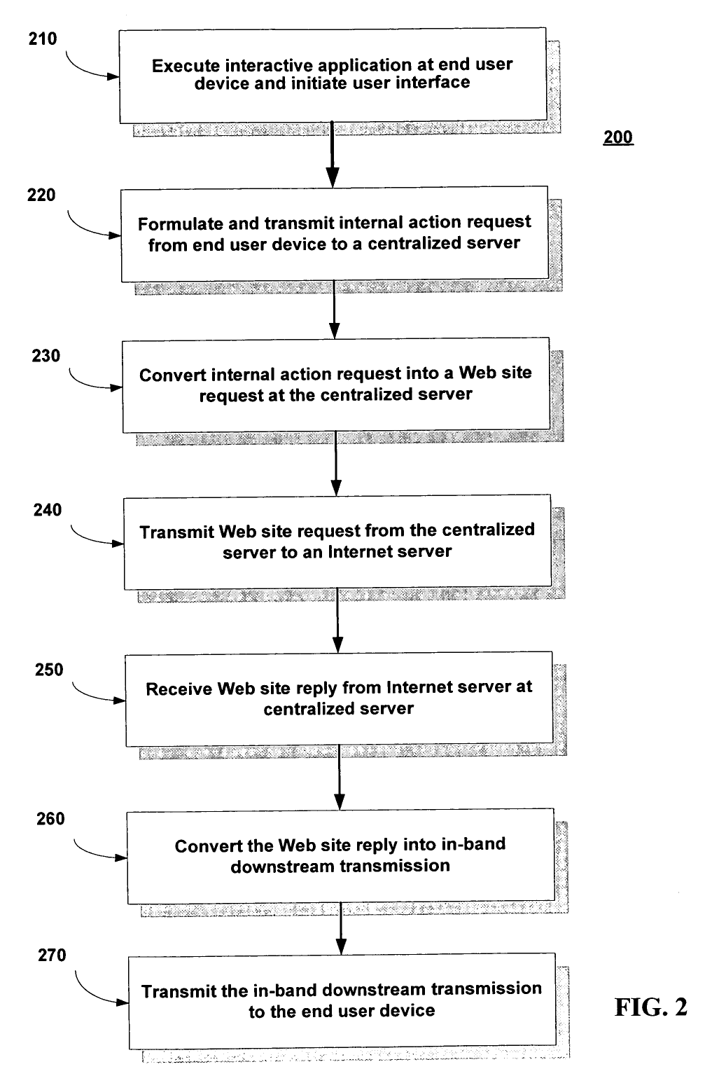

FIG. 2 illustrates an interactive communications process 200 according to an embodiment of the invention. In order to better illustrate the inventive concepts and improvements, the interactive communication process 200 is described in the context of facilitating end user interaction with an online auction, e.g., an auction hosted by eBay.com, via a cable television network, wherein the broadband network 20 is a HFC network and the end user device 10(a)-10(n) is a cable television set-top box. Nonetheless, the interactive communication process 200 should not be limited by such specific context and is certainly applicable to other types of broadband systems and other interactive services as noted above.

The interactive communications process 200 begins by executing (step 210) an interactive application at the end user device 10(a)-10(n). Execution of the interactive application can be initiated by the user selecting through an appropriate input device, a particular interactive service from a list of one or more interactive services displayed on end user display 15(a)-15(n). Depending on the storage resources available at the end user device 10(a)-10(n), the interactive application can be permanently stored in memory of the end user device 10(a)-10(n) or dynamically downloaded to the end user device 10(a)-10(n) upon each initiation of the process 200, i.e., at selection of the appropriate interactive service.

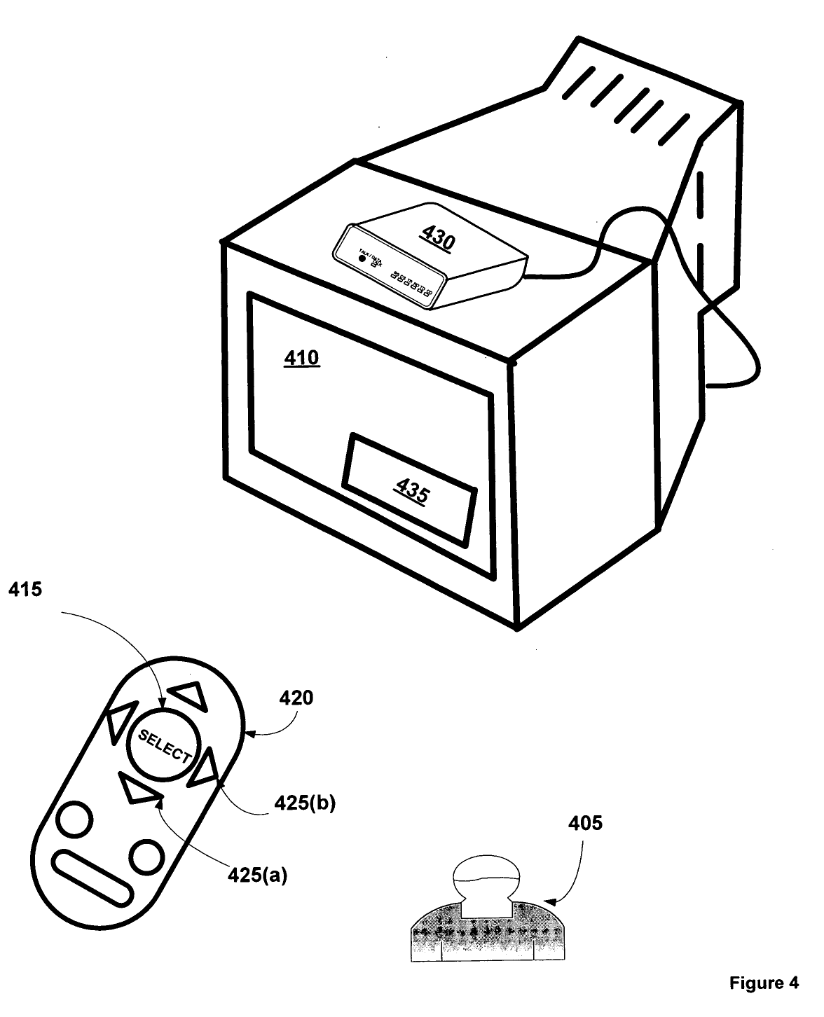

Once the interactive application is running, a user interface is displayed on end user display 15(a)-15(n) appropriate for that interactive service. The user interface is presented such that the user can use an input device such as, for example remote control 420 of FIG. 4 coupled to the end user device 10(a)-10(n) to navigate and select a certain action through predefined menus, the entry of keywords, the pressing of certain keys, etc. The user interface can take the form of drop-down menus, action lists, actions associated with specific keys on a remote control (e.g., arrow keys, A, B, and C function keys, the “Settings” key, the “Info” key, or number keys), frames, or a combination thereof.

Although the particular format of the user interface is not the focus of the present description, the format preferably enables the user to easily navigate and initiate certain actions appropriate for both the specific display device 15(a)-15(n) and the interactive Internet-based service employed. For instance, if the interactive application is directed to an Internet auction service, available actions include, but are not limited to: initiating user registration with the appropriate Internet server(s) 55 (e.g., eBay.com) hosting the online auction(s), upon activation of which the user is then prompted via the user interface to input appropriate registration information, which may include an email address via the input device, navigating through a predetermined list of relevant auctions and monitoring selected individual auctions, bidding on auction items, and performing a keyword search of relevant auction items, price ranges, time of auction, etc. that match the keyword.

In an embodiment of the invention, when the interactive application for online auctions (e.g., “eBay on TV”) is first executed, the user is prompted to either register with the auction Web server 55 (e.g., eBay.com if they are new eBay users) or to provide their existing username and password. Either way, this information is sent to the auction Web server 55 and the auction Web server 55 immediately responds with a secure token essentially a short string of seemingly random text that the auction Web server 55 associates with this user.

The security token is stored in the centralized server 35 along with the Media Access Control (MAC) or IP address that identifies the user's end user device 10(a)-10(n). By providing the security token in every communication with the auction Web server 55, the end user's identity is authenticated without having to store usernames and passwords in a database external to the Web server 55. The secure token generally functions the same was as an encrypted cookie given to a web browser by a web server and prevents an interloper from accessing the user's authorized username and password. A Personal Identification Number (PIN) is included that the user enters via the user interface immediately after registering. The correct PIN number is stored along with the security token at the centralized server 35. Every time thereafter that user invokes the interactive application for online auctions they have to provide the correct PIN to gain access. If they fail to provide the correct PIN number, they can not enter the application. In a related embodiment of the invention, after a predetermined period of user interactivity with the interactive service, the user is required to reenter the PIN to maintain access.

Once an action is selected by the user, e.g., to monitor a particular online auction in progress, an internal action request is formulated at the end user device 10(a)-10(n) and transmitted (step 220) via an upstream channel of the broadband network 20 and routed to the centralized server 35. For instance, the end user device 10(a)-10(n) may encapsulate IP packets comprising the internal action request into an out-of-band upstream channel of the broadband network 20. At the backend gateway 25, the IP packets are extracted and transmitted on the IP network 40 to the centralized server 35.

In an embodiment of the invention, the internal action request is a string comprising an identifier of the end user device 10(a)-10(n) from which it was sent and data associated with the user's underlying interactive action, which, in the case of monitoring a particular online auction, is an identifier associated with that particular auction, e.g., an eBay auction identification number. The centralized server 35 converts (step 230) the internal action request into a Web site request using a standard communications format, e.g., in Extensible Markup Language (XML), which includes the secure token and the user's underlying interactive request. Web site request is then transmitted (step 240) to the appropriate Internet server 55, e.g., eBay.com.

In an embodiment of the invention, the centralized server 35 communicates with the respective Internet server 55 by implementing a set of XML/Remote Procedure Calls (RPCs) provided by the Internet server 55, thereby granting direct access into the Internet server 55. XML/RPC is a mechanism for programs executing on two distinct computers to “call” functions within each other by encapsulating the function call and response data in an XML format, and transporting it via a standard Hypertext Transfer Protocol (HTTP) (i.e., Web) infrastructure. In another embodiment of the invention, the centralized server communicates with the publicly accessible Internet server 55 via HTTP, generating messages in an HTML-based format as would be produced by a conventional web browser. One of ordinary skill in the art understands that communication with the centralized server 35 and Internet server 55 may involve any of a wide variety of communication protocols, message formats, and security measures as are common in the state of the art to communicate the essential request and response information required by interactive applications.

Upon processing of the Web site request, the Internet server 55 generates an appropriate Web site reply that is received (step 250) by the centralized server 35. The centralized server 35 converts the Web site reply into an in-band downstream transmission (at step 260), which the backend gateway 25 transmits to the end user device 10(a)-10(n) over a downstream channel (at step 270). For example, to request information about an auction, the Web site request specifies the auction number. The Web site reply comprises auction data in XML format, possibly including an image in Joint Photographic Experts Group (JPEG) format. The centralized server 35 converts this XML data of the Web site reply into an appropriate format for transmission down to the end user device 10(a)-10(n). In order to avoid wasting valuable bandwidth, the XML data is trimmed down to just that needed for display on the end user display 15(a)-15(n). If the XML data includes an image, the image can be resampled into a predetermined format and/or resolution, e.g., in order to make it occupy less space and/or bandwidth.

Note that an in-band transport mechanism is not necessarily required for downstream transmission of the converted Web site reply. In small television markets, features are restricted such that the bandwidth requirements of the downstream transmission are low enough to use strictly out-of-band. However, in the general case, big markets (e.g., New York City) may not be able to handle all the traffic out-of-band. In these cases, some of the downstream data transmission is off loaded to the in-band data carousel 30.

In an embodiment of the invention, first, the in-band data carousel 30 is only used for detailed auction information (e.g., auction descriptions and images). All other data is sent to the end user device 10(a)-10(n) out-of-band. Second, the in-band data carousel 30 is simplified by using an FIFO mechanism. Without such an unconventional modification, the end user devices 10(a)-10(n) would have to request for particular data/information to be put on the in-band data carousel 30 and later request that it be removed because carousels can only hold a limited amount of data. This way, whenever the user does a search returning a list of auction headers, all of the detailed information for those auction items is pre-loaded onto the in-band data carousel 30. Thus, the end user device 10(a)-10(n) never has to request that those items be put on the carousel 30, which saves bandwidth. And because items are removed from the carousel when it gets full, using a FIFO strategy, the end user device 10(a)-10(n) never has to request that the item be removed from the carousel 30. In the unlikely event that detailed information is needed that is not on the carousel 30, the end user device 10(a)-10(n) can send a request for it out-of-band. The data may then be sent downstream to the end user device 10(a)-10(n) either out-of-band, or as a dynamic, in-band HTTP response via the carousel 30, as described above.

Upon reception, the end user device processes the downstream transmission and outputs the Web site reply in a format appropriate for display on the end user display 15(a)-15(n). For example, standard data carousel software is employed at the end user device 10(a)-10(n) to extract the requested files from the carousel 30, the implementation of which is apparent to one of ordinary skill in the art. For subsequent interactive actions selected by the user, the process is repeated (starting at step 220).

In an embodiment of the invention, once the user has placed a bid on an auction item via the interactive communication process 200 as operated by the user and his/her input device, e.g., remote control, an automatic alert is sent from the Internet server 55 to the centralized server 35 notifying the user if he/she has been outbid in the auction. The alert is then forwarded downstream to the end user device 10(a)-10(n) and the end user display 15(a)-15(n) notifies the user about the option of submitting a higher bid. For example, an outbid alert is sent by the Internet server 55 to the centralized server 35 with the username or some other identifier for the recipient (e.g., user of end user device 10(a)-10(n)) of the alert.

Note that when the user is first registered with the Internet server 55, the IP address of the backend server 35 is specified as one of the alert recipients for that user. The username is mapped to (associated with) a specific end user device 10(a)-10(n) IP address. The alert is reformatted for the broadband network 20 and sent to the specified end user device 10(a)-10(n). In a cable television environment, generally, all alerts are transmitted to the set-top box 10(a)-10(n) out-of-band. The set-top box 10(a)-10(n) typically can only receive in-band data by tuning away from the video. For a user to get an alert while watching video, the alert must generally come down out-of-band.

In an embodiment of the invention, any type of alert (e.g., a severe weather alert) generated by an Internet source can be delivered to the end user device 10(a)-10(n). Particularly, the centralized server 35 receives an alert message generated by an Internet source 55. The centralized server 35 converts the alert to a standard format, which is then routed and transmitted to an to appropriate device on the broadband network 20, e.g., a set-top box, by employing a mapping table or database that maps whatever user-id the Internet server 55 uses into the IP address of the user's set-top box. The alert is displayed on the end user display 15(a)-15(n). The user's response thereto is then captured (e.g., by a certain key-press on the remote control) and an interactive application is activated to process the response.

For example, if the user receives an “outbid” alert from an auction server 55, the user is given the option to hit a key on an input device to invoke the interactive auction application, thereby displaying the interactive application's user interface and presenting the user with the opportunity to submit another bid. The response is then forwarded back to the originator of the message, i.e., the Internet server 55.

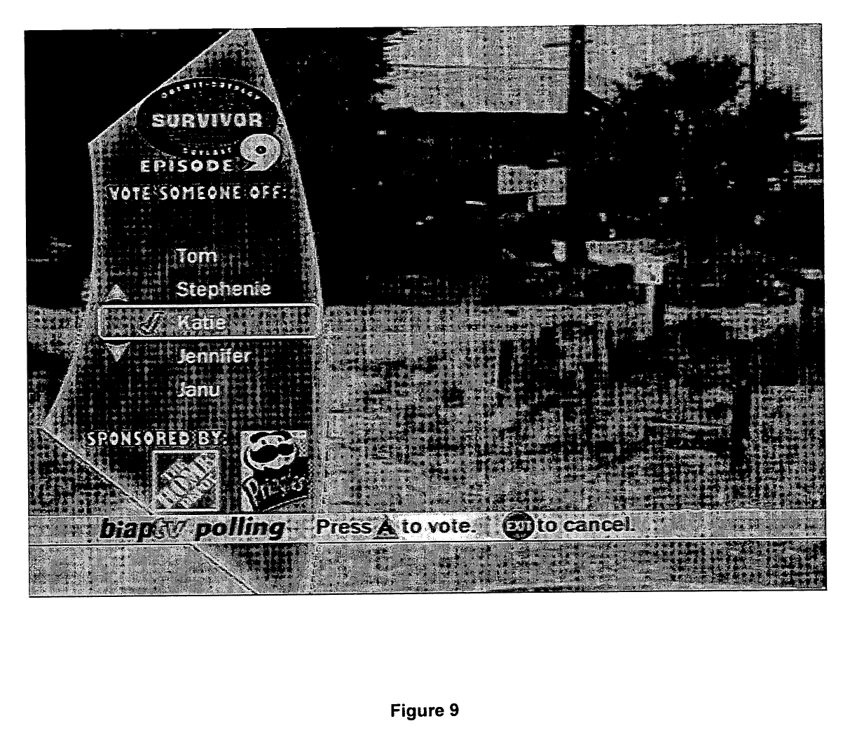

Voting and Polling, as depicted in FIG. 9, is an interactive application configured to run topical polls, trivia questions and/or quizzes relating to what is known in the industry as “reality TV.” Reality TV shows include, by way of non-limiting example, Fox's American Idol, ABC's The Contender, CBS's The Amazing Race, and CBS's Survivor. The interactive application may be implemented in a voting interactive situation, such as viewers voting for who should win an entertainment category e.g., an Oscar, Emmy, Grammy, etc., who is likely to be the most valuable player in a sports event, or which contestant should be voted off of a show like “Survivor”, “Big Brother”, etc. In such a situation, the responses (e.g., vote counts) can be aggregated at the centralized server and then transmitted to the Internet server 55 for it to be utilized in real-time. Alternatively, to minimize peak upstream bandwidth usage, poll results may be sent from the end user device 10(a)-10(n) after a random time interval so that upstream messages are spread out over that interval instead of flooding in at once from many poll respondents.

In another embodiment of the invention, a software agent is scheduled at specific times in a repeated fashion, and at specified time intervals, to execute either on the centralized server 35 or the end user device 10(a)-10(n) and create a network connection out to the Internet server 55 and retrieve content. Based on some pre-defined conditions on that content, an alert can be generated by the centralized server 35 or end user device 10(a)-10(n). For example, an Internet weather server or user e-mail server can be monitored to alert the end user of severe weather conditions or new e-mail from pre-defined people, respectively.

In an embodiment of the invention, once the user has won an auction item by outbidding all other bidders, the centralized server 35 automatically completes the commerce cycle on the user's behalf. For instance, the centralized server 35 receives an alert from the Internet server 55 when the auction is over and the user's broadband network account, secure token, or end user device 10(a)-10(n) may be linked to a PayPal account, Visa account, or other financial account. Once the centralized server 35 identifies the user as having successfully bid and won an auction item, the centralized server 35 automatically provides the Internet server 55 with the user's appropriate financial information, e.g., a credit card number, billing and shipping address, etc., and hence completes the commerce cycle. The Internet server 55 then processes the user's payment and causes the item to be shipped to the supplied shipping address.

In an embodiment of the invention, the ability to automatically complete the commerce cycle as described above can be activated and deactivated by the user via the user interface provided by the interactive application executing on the end user device 10(a)-10(n). For security purposes, the user can be required to enter a predetermined authorization code, e.g., the PIN number noted above.

In another embodiment of the invention, payment of the purchase price can be debited to an account associated with the user and handled by the provider of the broadband network 20, e.g., a cable television account/bill. The above described completion of the commerce cycle applies equally as well to a purchase of an online sales item initiated through the end user device 10(a)-10(n). A user can bid on an Internet auction item or purchase a sale item available on a Web site through his television remote control, immediately leave for vacation thereafter, and then arrive back at his home with the auction or sale item waiting at his doorstep.

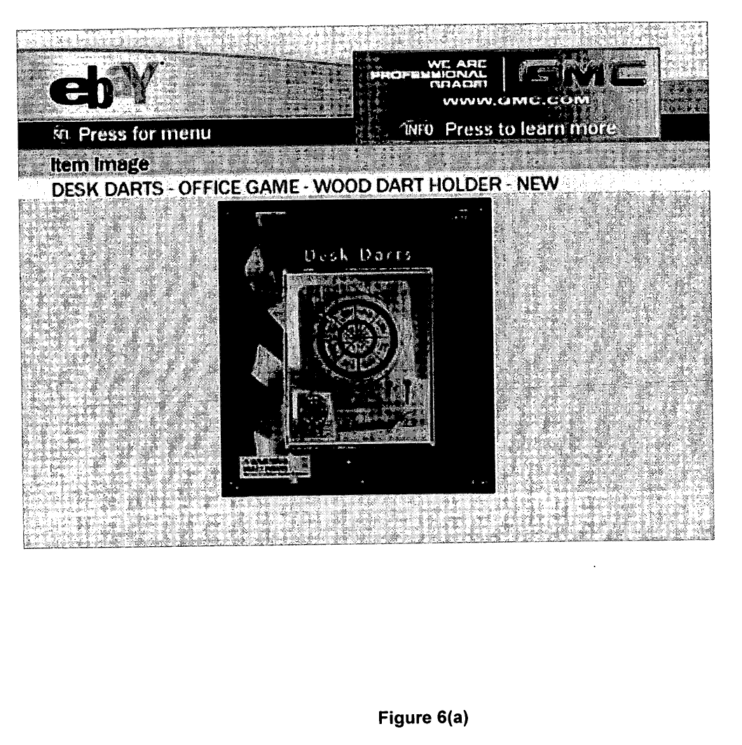

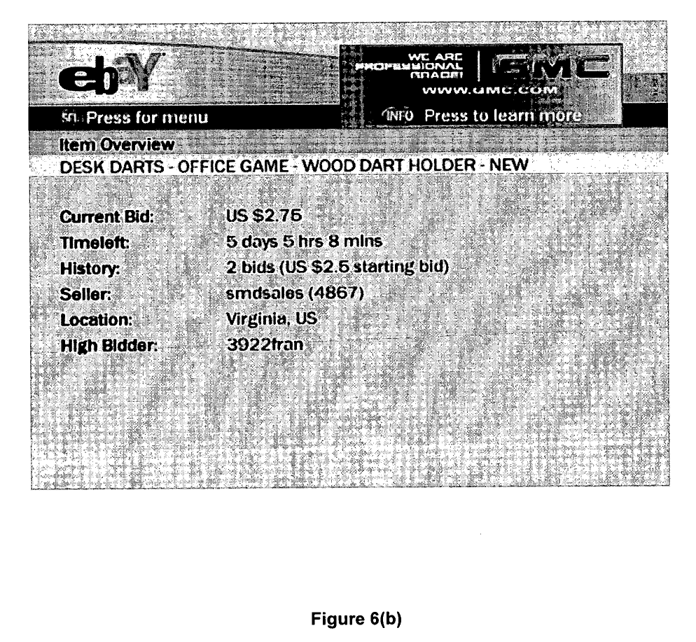

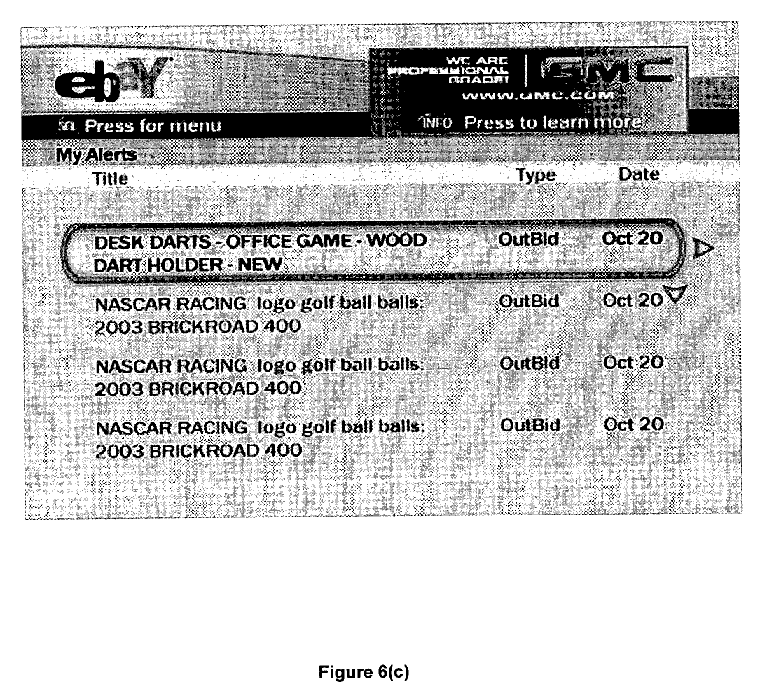

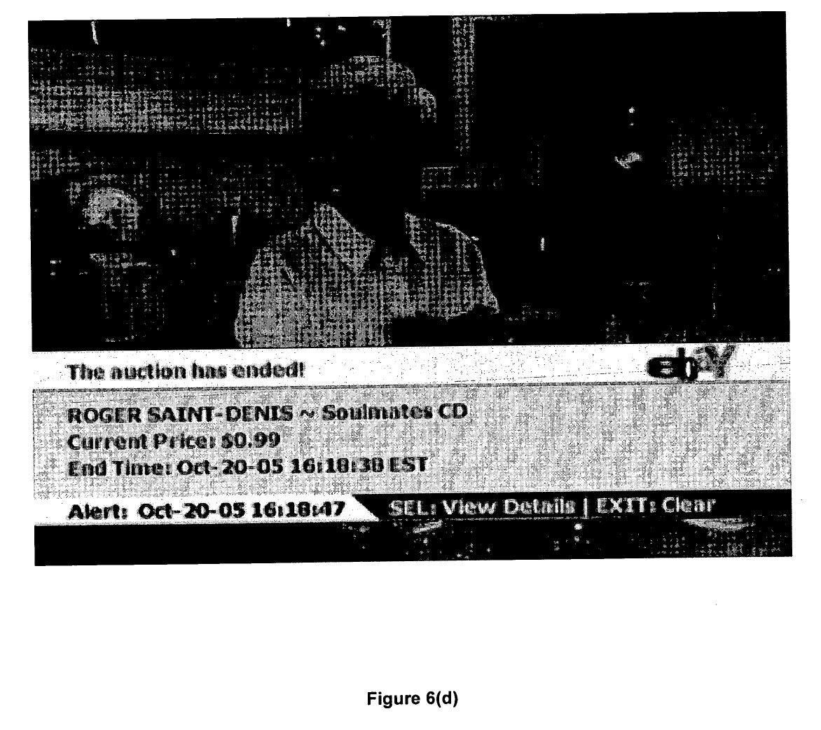

FIGS. 6(a)-(d) are screen-shot illustrations of interactive applications generated on a television screen. These figures illustrate a user interface for an auction item on eBay, including item-specific information, such as “current bid”, “time left,” “bid status,” and an alert display as a ticker. In particular, FIG. 6(a) depicts a portion of a screen presented to a user regarding a wood dart holder product for sale on Ebay. Such a screen may be presented to a user in a region of a screen otherwise devoted to viewing, for example, broadcast content. FIG. 6(b) depicts a screen detailing purchase information regarding the product displayed in the screen of FIG. 6(a). FIG. 6(c) depicts a screen denoted “My Alerts.” Such a screen may contain information such as notifications that a user's bid on an item in an online auction has been surpassed by another user. That is, the screen of FIG. 6(c) may contain alerts that the user has been outbid. FIG. 6(d) depicts an overlay on a screen otherwise devoted to displaying, for example, broadcast content. The overlay includes an alert that a particular auction of interest to the user has ended.

In an embodiment of the invention, up and down arrows are provided on the end user device 10(a)-10(n), or a remote control linked to the end user device 10(a)-10(n), to increase and decrease, respectively, the amount of an auction bid. The increase and decrease may be set to any incremental amount, e.g., 1 cent to a fixed amount of dollars. In a related embodiment of the invention, pre-defined bid amounts (e.g., minimum, maximum, typical) are mapped to specific keys on the remote control allowing single-key press bidding. In another embodiment of the invention, a user's previous search criteria responses are mapped to keys on the remote control to facilitate easy reentry. Similarly, the interactive application may auto-suggest words in an advanced search mode.

In an embodiment of the invention, auction feedback comments about the seller can be selected by the user, i.e., purchaser, from a pre-defined list of frequently used comments mapped to specific keys on the user's remote control keys, thereby enabling single key-press entry of comments. In a related embodiment, the user is provided with auction feedback comments from a large, pre-defined list of standard comments selectable in the user interface via up and down keys provided on the remote control.

In an embodiment of the invention, the centralized server 35 provides automatic summarization of auction item for easy analysis in an interactive TV environment. For example, the centralized server 35 may process the Web data received from the Internet server 55 concerning multiple auctions that the user has selected via the end user device 10(a)-10(n) for monitoring. Such processing includes, but is not limited to reformatting the Web data received into a television format optimized for providing the most relevant information regarding the online auctions without cluttering the television picture displayed on the end user display 15(a)-15(n). For instance, a conventional statistical method may be employed, the implementation of which is apparent to one of ordinary skill in the art. In a related embodiment, the centralized server 35 and/or end user device 10(a)-10(n) automatically highlights important keywords in an auction description for easy analysis in an interactive TV environment.

In an embodiment of the invention, detailed information and photos of the auction items are loaded on the dynamic in-band carousel 30 for immediate access by the interactive application executing on the end user device 10(a)-10(n). A fixed amount of data on the in-band data carousel 30 may be maintained by deleting items in a first-in-first-out (FIFO) order. In a related embodiment of the invention, detailed information and photos of auction items are requested by the interactive application executing on the end user device 10(a)-10(n), said request is transmitted via the broadband network 20, backend gateway 25, and communications network 40 to the centralized server 35, said server retrieving the requested data and transmitting it to the end user devices 10(a)-10(n) as a dynamic in-band HTTP response on the in-band data carousel 30, as described above.

In an embodiment of the invention, preference learning is implemented to refine user searches. For instance, a preference learning algorithm monitors user interaction to learn about user's likes and dislikes. When the user performs a search (e.g., of eBay auctions), matching items may be sorted based on user preferences, and low-ranking items ignored, saving bandwidth and enhancing interactivity. In a related embodiment of the invention, additional search criteria are employed to refine a user's search. For instance, additional search criteria, either explicit or implicit (e.g., saved responses) are gathered prior to the search. These criteria provide better and fewer matches, enhancing interactivity and saving bandwidth.

In an embodiment of the invention, the interactive application is directed to an Internet-based online retail sales provider, e.g., Wal-Mart™, Apple iTunes™, etc. Available actions include, but are not limited to: initiating user registration with the appropriate Internet server(s) 10 (e.g., Walmart.com) hosting the online store, navigating through a predetermined list of relevant sales items, selecting a sales item to bring up information about the sales item, and purchasing a selected sales item. In such an embodiment, the centralized server 35 converts internal action requests sent by the end user device 10(a)-10(n) into appropriate Web site requests and then transmits the Web site requests to the online retailer's Internet server 55. The centralized server 35 then converts the reply from the Internet server 55 into an out-of-band downstream transmission, which the backend gateway 25 routes to the end user device 10(a)-10(n) over a downstream channel. Alternatively, the centralized server 35 converts the reply from the Internet server 55 into a dynamic in-band HTTP response via the carousel 30, as described above. One of ordinary skill in the art understands that any response received from an Internet server 55 may be divided into multiple parts, each part being sent downstream to the end user device 10(a)-10(n) via either an out-of-band or in-band mechanism, as is most appropriate for each part of the response data.

In other situations, the following interactive communications process may be better suited for a particular interactive application. In an exemplary embodiment of the invention, an interactive application facilitates user interaction with a fantasy sports Web site, e.g., Yahoo fantasy football, by a user of the end user device 10(a)-10(n). In brief, fantasy sports are games where participants select a certain number of professional athletes in a particular sport. Depending on the actual performance of each professional athlete, the participant, i.e., “fantasy owner,” is awarded with a certain number of points. Participants compete against one another based on the number of points they are awarded. A fantasy sports Web site typically makes available a finite amount of data, i.e., player and/or team stats, as there are a finite number of teams, players, and games occurring for any given time period.

In one embodiment of the present invention, the centralized server 35 stores all fantasy sports data in an internal database, and interactive applications executing on end user devices 10(a)-10(n) each send customized requests to the centralized server 35 for the specific pieces of information of interest to the end users of each end user device 10(a)-10(n). As described above, each response from the centralized server 35 downstream to an end user device 10(a)-10(n) could be sent either out-of-band or via a dynamic in-band HTTP response through the carousel 30. Alternatively, rather than having users of the end user devices 10(a)-10(n) request information from the fantasy sports Web site repeatedly as games develop, the entire finite amount of fantasy sports data may be downloaded from the fantasy sports Web site to the in-band data carousel 30 on a periodic basis. This finite amount of data is then broadcast on an in-band television channel to the end user devices 10(a)-10(n). This effectively reduces the number of upstream transmissions that would accompany requests for such information from individual users of end user devices 10(a)-10(n).

In an embodiment of the invention, there are two parts to the interactive application for fantasy sports, both of which could stand alone. First, there is the display of personalized game statistics—i.e., for a user's fantasy team—as the games are being played (and afterward). A “feed” may be taken from a sports data provider, i.e., the respective Internet server 55. Depending on the provider, the data is received as the source pushes it out to the centralized server 35 (i.e., the centralized server 35 does not have to request anything), or the centralized server 35 periodically requests and downloads changes. In effect, the entire database of current “fantasy sports” information is loaded and broadcast to the end user devices 10(a)-10(n) on the in-band data carousel 30. Each end user device 10(a)-10(n) then watches the data go by and pulls out the specific data for their respective fantasy teams and players for display. In an alternative embodiment, the entire database of fantasy sports information is stored on the centralized server 35 and requested as needed by the end user devices 10(a)-10(n) executing the fantasy sports application. The second part of the application is the connection to an existing fantasy sports Web site, like Yahoo! or FanBall.com. This would allow the user to not only see the stats on his/her respective players, but also to see his/her points and his/her standing in the fantasy league in which he/she is playing.

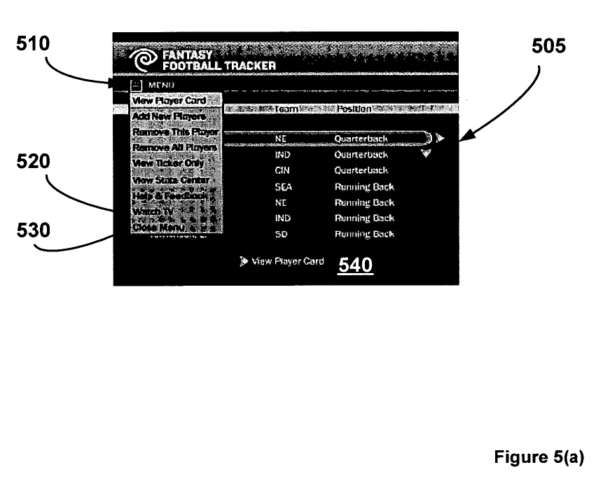

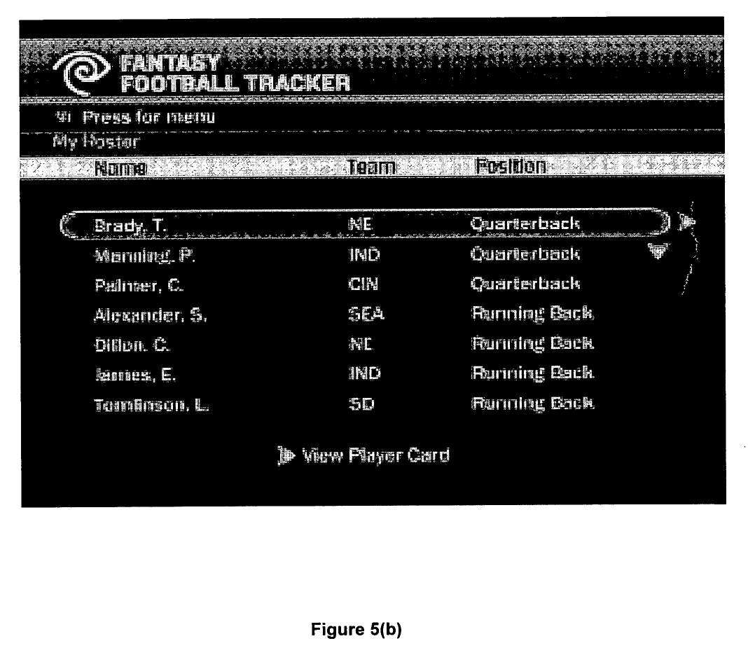

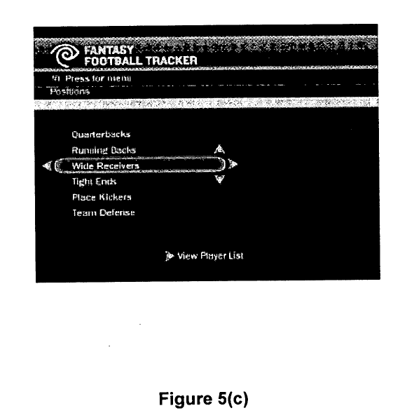

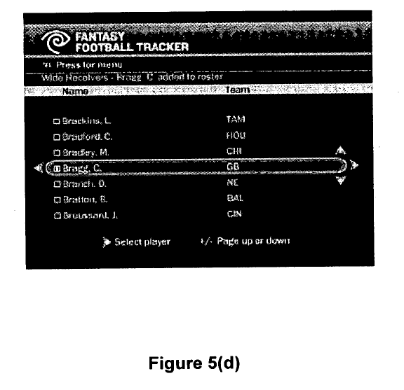

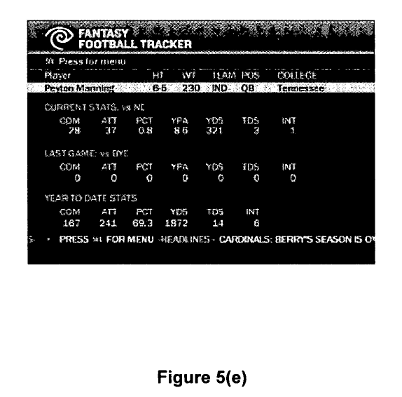

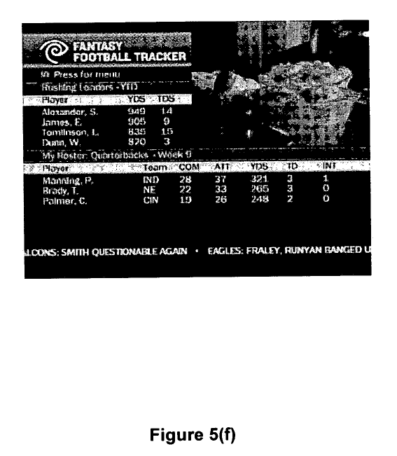

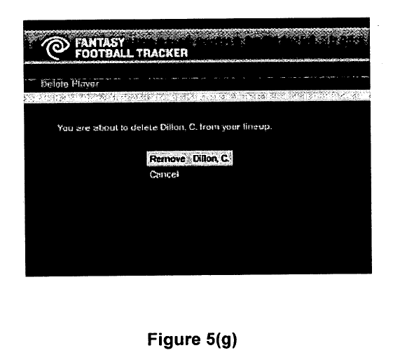

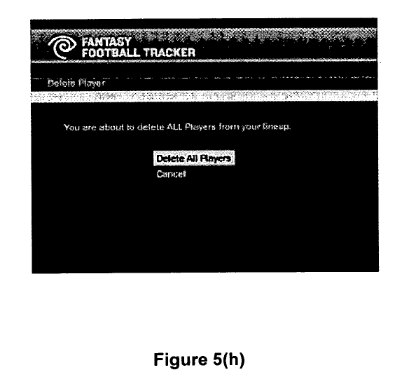

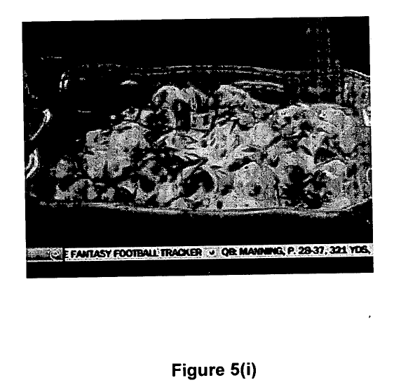

FIGS. 5(a)-(i) are screen shots illustrating the system and method of the present invention for creating, editing, managing and receiving fantasy sports data, in this situation, a football fantasy sports data. FIG. 5(a) depicts a fantasy football tracker user interface 505. A user may select various options from menu 510, such as “watch TV” 520 and “close menu” 530. Interface 505 further includes links to other interfaces, such as link 540, which allows a user to view statistics relating to an individual player. FIG. 5(b) is a detail of FIG. 5(a). In particular, FIG. 5(b) shows various players on a user's fantasy football team.

FIG. 5(c) depicts a menu that allows a user to select all players in certain positions. FIG. 5(d) depicts a screen that results from a user selecting “Wide Receivers” from the menu of FIG. 5(c). A user may scroll through the list of players depicted in the screen of FIG. 5(d) and make various selections, such as adding a particular player to the user's roster. FIG. 5(e) depicts a screen devoted to an individual football player. The screen of FIG. 5(e) includes individual statistics, such as (for a quarterback), passes completed, total yards, and interceptions. FIG. 5(f) depicts a screen that includes information on the user's fantasy football team, a scrolling ticker at the bottom of the screen that includes news information on individual players, and a picture-in-picture display of a media channel, such as a broadcast television program. FIG. 5(g) depicts a screen that allows a user to remove a player from the user's fantasy football lineup. FIG. 5(h) depicts a screen that allows a user to remove all players from the user's fantasy football lineup. FIG. 5(i) is a screen-shot of the interactive application illustrating viewing by the subscriber a television channel of their choice, while receiving information of his/her fantasy football players in a ticker format at the bottom of the television screen.

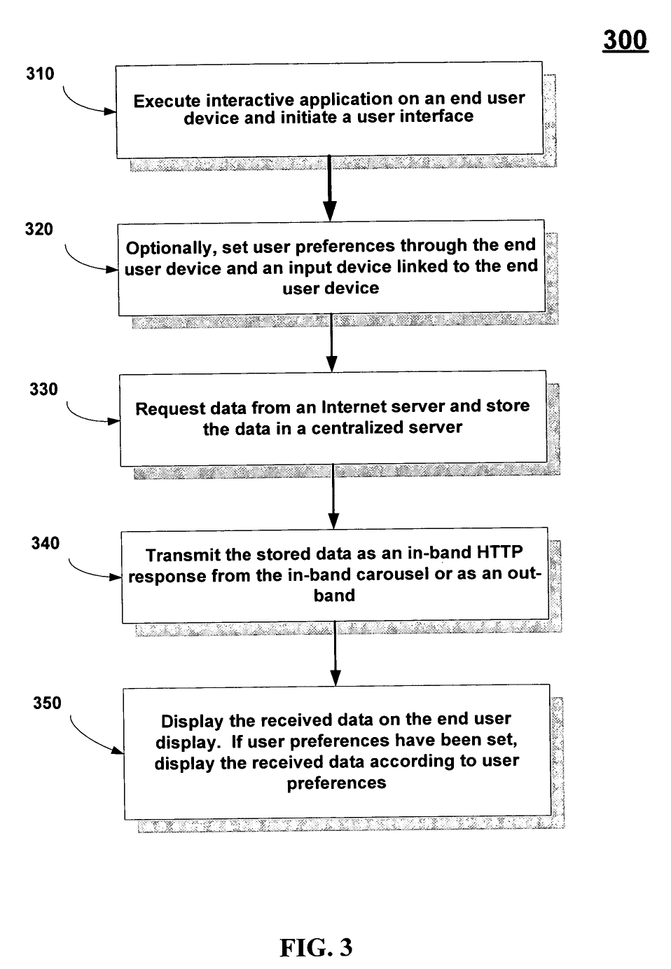

FIG. 3 illustrates an interactive communications process 300 according to an embodiment of the invention. The interactive communications process 300 begins by executing (step 310) an interactive application at end user device 10(a)-10(n). For example, the user selects via a remote control linked to the end user device 10(a)-10(n) an interactive application associated with a fantasy sport, such as football. At any time thereafter, the user can then navigate and optionally select (step 320) through the user interface the action of setting personal preferences. For example, in the fantasy sports interactive application, the user can select via the remote control certain players he/she wishes to monitor from a list of players. Operating in the background concurrently or at a previous time, the centralized server 35 requests (step 330) or automatically receives data, i.e., fantasy football data, from the Internet server 55 making the data available.

The received data is then stored in the centralized server 35, which then transmits (step 340) the data to the end user device 10(a)-10(n) either out-of-band, or via a dynamic in-band HTTP response through in-band data carousel 30. The end user device 10(a)-10(n) then displays (step 350) the received broadcast data on end user display 15(a)-15(n). In the event that the user has set certain preferences, e.g., selected certain professional football players that the user wishes to view the stats thereof, the end user device 10(a)-10(n) filters the received broadcast data and displays the broadcast data according to the user's preferences. For instance, if the user has set in his preferences that he wishes to only monitor the stats of three particular football players, only the stats of those three football players will be displayed.

In an embodiment of the present invention, and in reference to FIG. 1, the interactive communications process begins by executing an interactive application by an end user device 10(a)-10(n). For example, the end user may select via a remote control linked to the end user device 10(a)-10(n) an interactive application associated with fantasy sports, such as football.

In reference to FIG. 4, the end-user, referred to from here on as a digital cable subscriber 405 may activate any one of the aforementioned internet-based services on digital television 410 which is connected to a digital set-top box 430, by pressing the ‘Select’ key 415 of remote control unit 420 to launch an “Access Menu”. During the loading of the application, the digital cable subscriber 405 is presented with an application user interface, which may be generated on the upper left-hand side of the television screen, such as the one shown in FIG. 5. At any time, the subscriber may opt to exit the interactive application by electing a “Watch TV” 520 option from the menu.

Although the interactive communications process 300 has been described in the context of fantasy football, the process 300 is well suited for other interactive applications. For example, an interactive application may be directed to certain financial news such as, but not limited to stock market quotes. In such a scenario, financial data retrieved from a financial Internet server 55 is stored at the centralized server 35, which is then transmitted downstream to the end user device 10(a)-10(n). A user may set preferences such that only certain stock market quotes of interest are retrieved or displayed.

The interactive communications process 300 is particularly well suited where the broadband network 20 is a satellite television network. Because there is no efficient backchannel, e.g., no real time capability exists by using an upstream phone line, all the applicable data (e.g., fantasy sports or financial data) can be first downloaded from the appropriate Internet server 55 and then broadcast over the satellite network 20. The satellite receiver 10(a)-10(n) can then pick and choose from that broadcast data the relevant data needed for display on the television display 15(a)-15(n).

In an embodiment of the invention, the broadband network 20 is a cellular network and the centralized server 35 operates at a regional or national office of the cellular network. In this scenario there is no concept of in-band or out-of-band as noted above. The end user's interactive experience is specifically tailored based on the type of end user device 10(a)-10(n) (i.e., cell phone or PDA) employed. For example, the centralized server 35 and/or end user device 10(a)-10(n) can reformat the respective data obtained from the Internet server 55 for optimal display on the display 15(a)-15(n).

In an embodiment of the invention, the broadband network is an IPTV network and the end user device 10(a)-10(n) is a set-top box acting as an IP node. Web data obtained from the Internet server 55 is cached in the centralized server 35. The end user device 10(a)-10(n) requests one or more portions thereof and those portions are embedded into an MPEG video stream, which is then sent downstream to the end user device 10(a)-10(n).

In an embodiment of the invention, embedding targeted, local advertising is included in the interactive TV applications described above. Such advertising can be targeted according to the type of Internet application implemented, for example, if an auction Web site is being accessed, advertising relative to that Web site can be displayed. Other advertising can be displayed based on predetermined user preferences, which are identified by standard techniques, the identification and implementation of which is apparent to one of ordinary skill in the art.

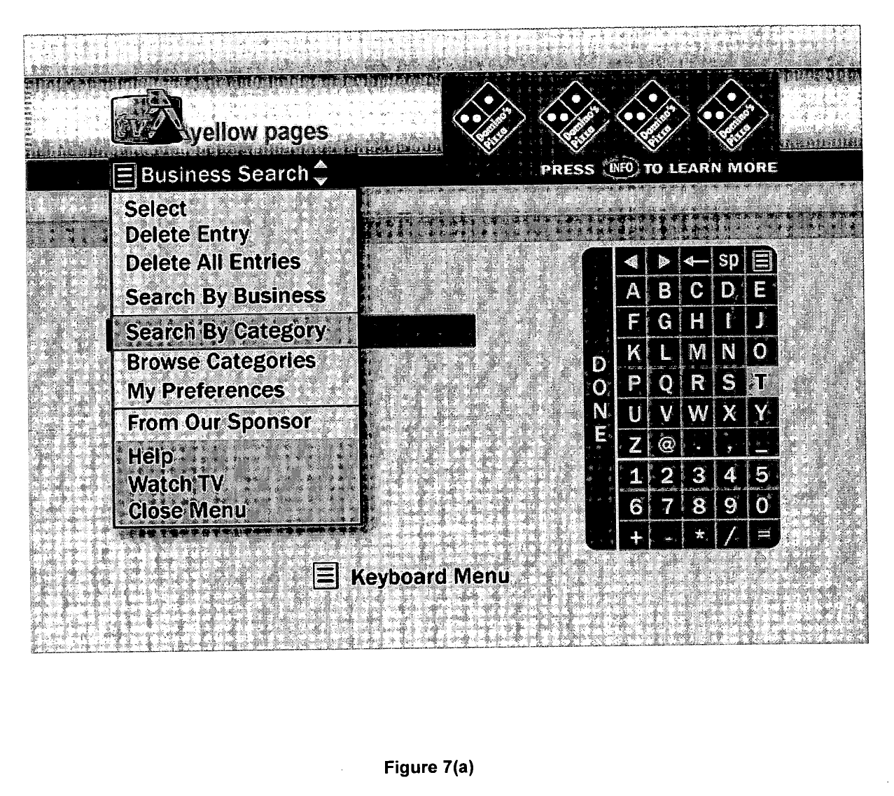

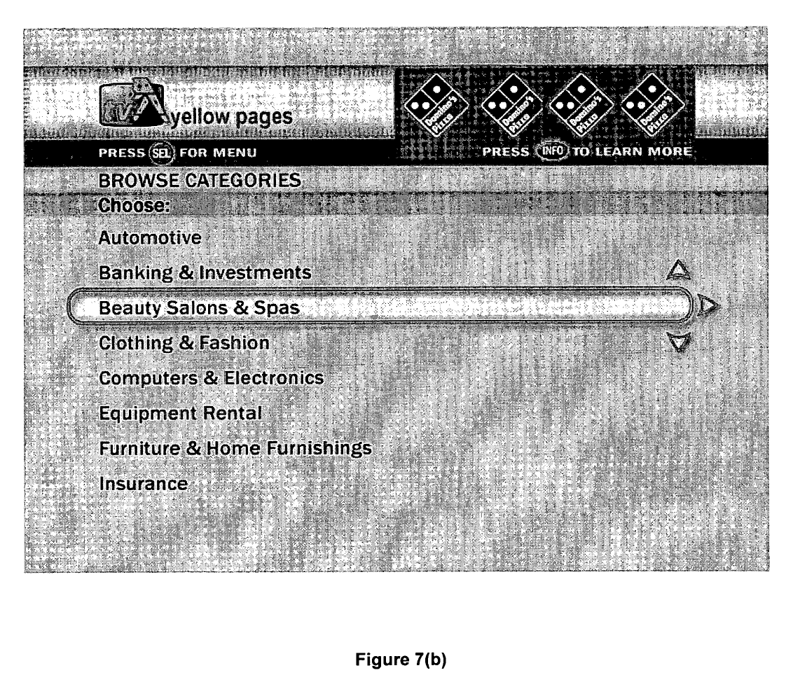

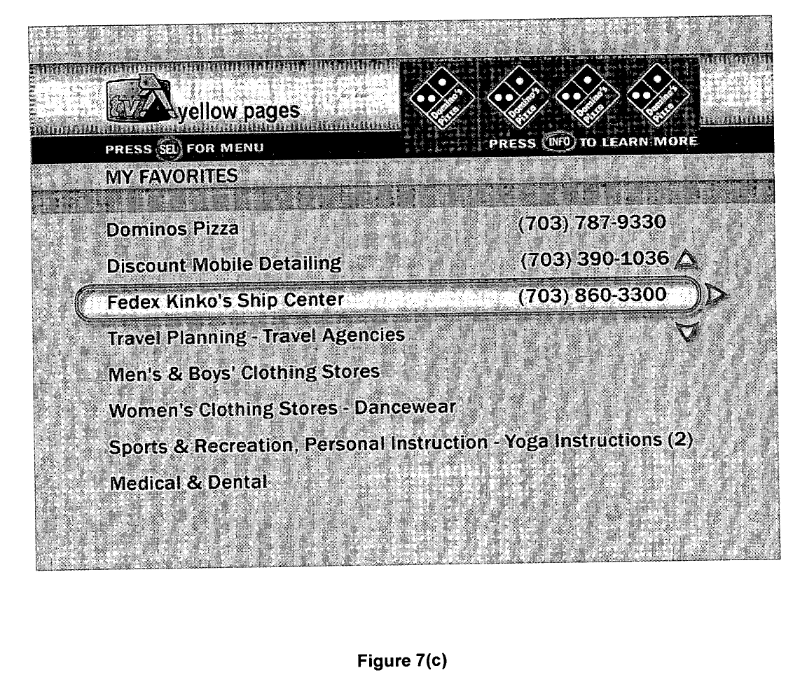

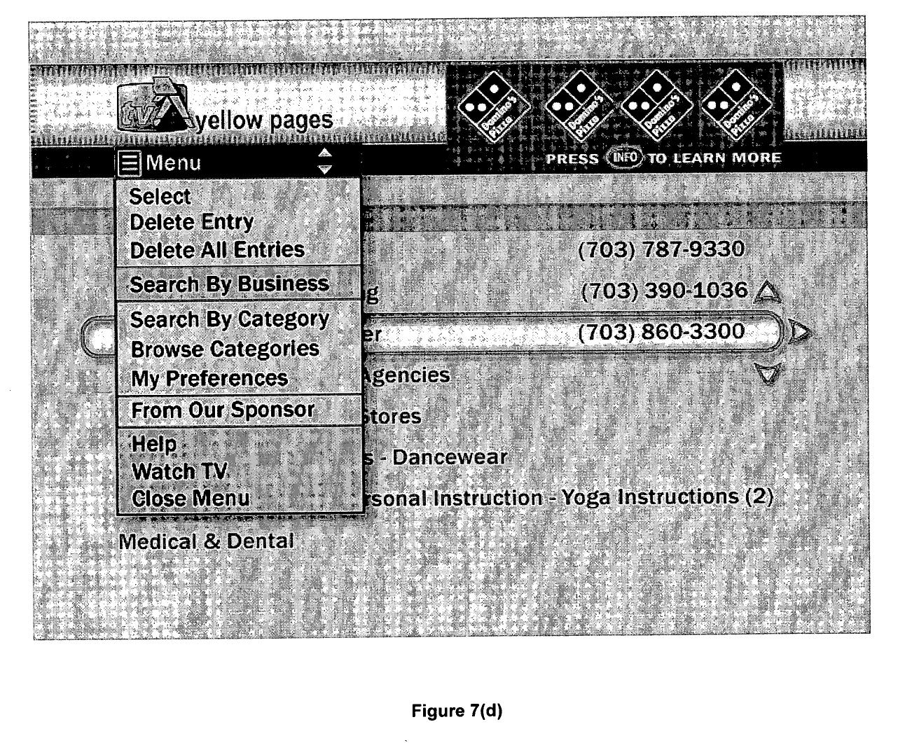

FIGS. 7(a)-7(d) depict screenshots relating to a Yellow Pages business search. In particular, FIG. 7(a) depicts a search for a business where the user is allowed to search by category for a particular business. The screen of FIG. 7(a) includes an advertisement that may be generated in relation to the search conducted by the user. FIG. 7(b) depicts a screen that allows a user to scroll through categories that are available for searching. FIG. 7(c) depicts a screenshot of a collection of favorite businesses and categories selected by the user. A representation of such a collection may be stored locally for retrieval at any time. Entries may be added to or deleted from the collection of favorite businesses and categories by activating a menu as illustrated in FIG. 7(d).

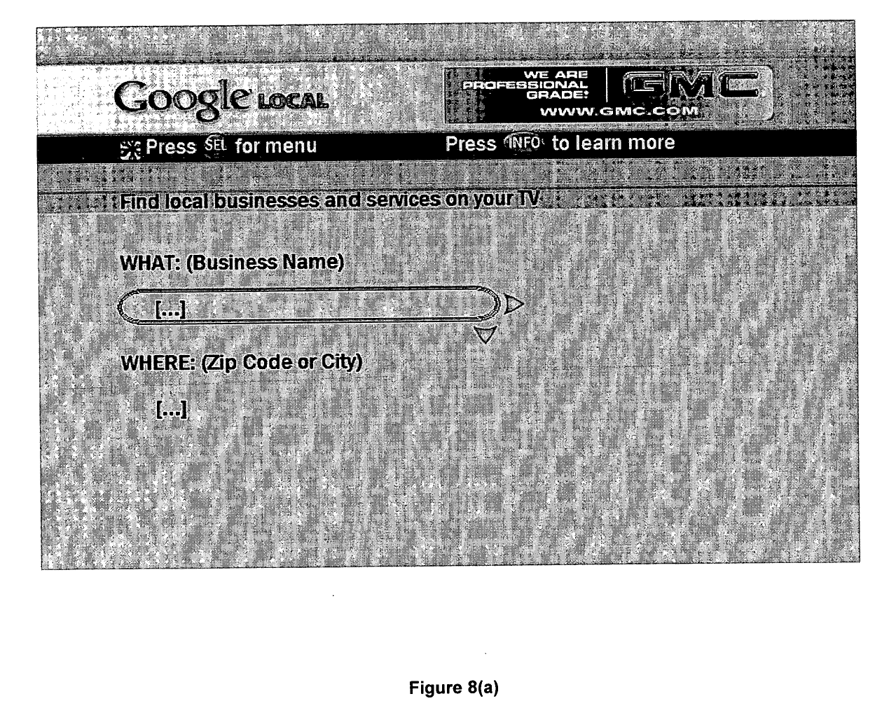

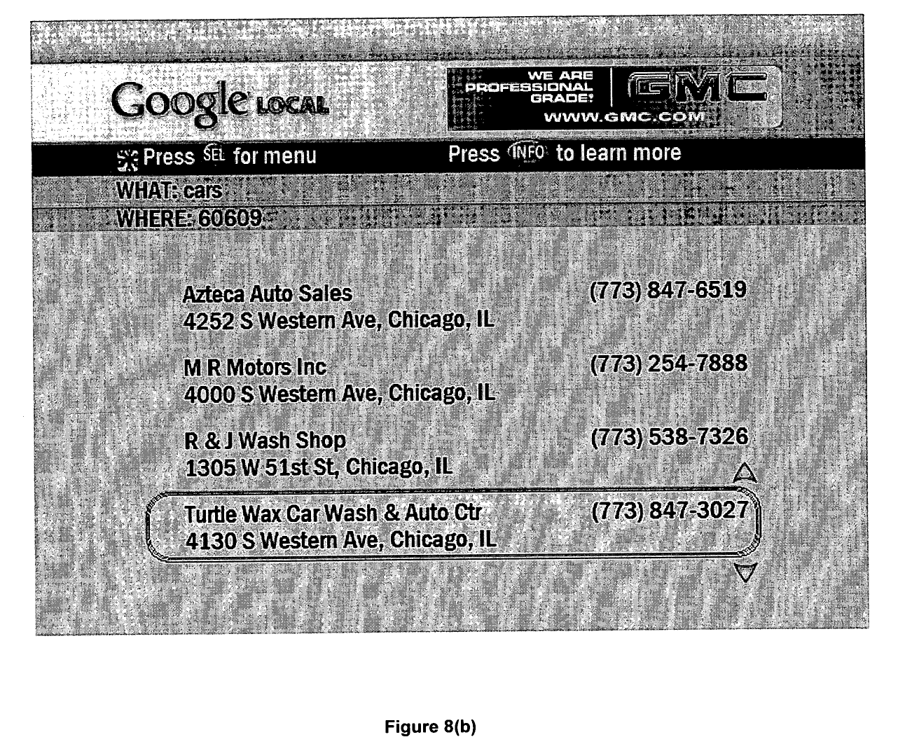

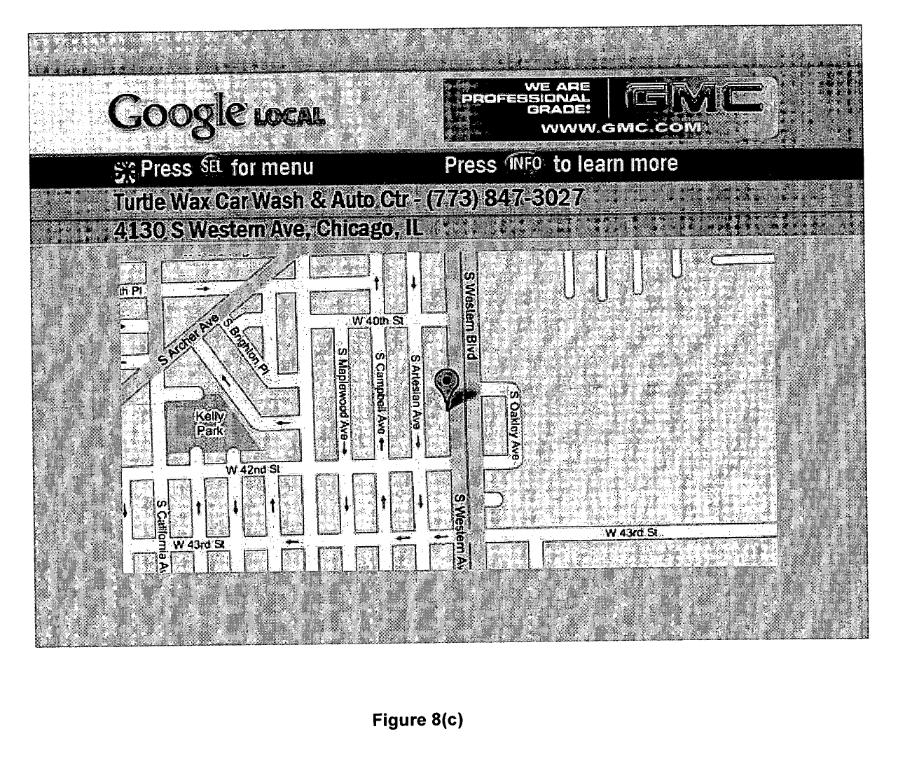

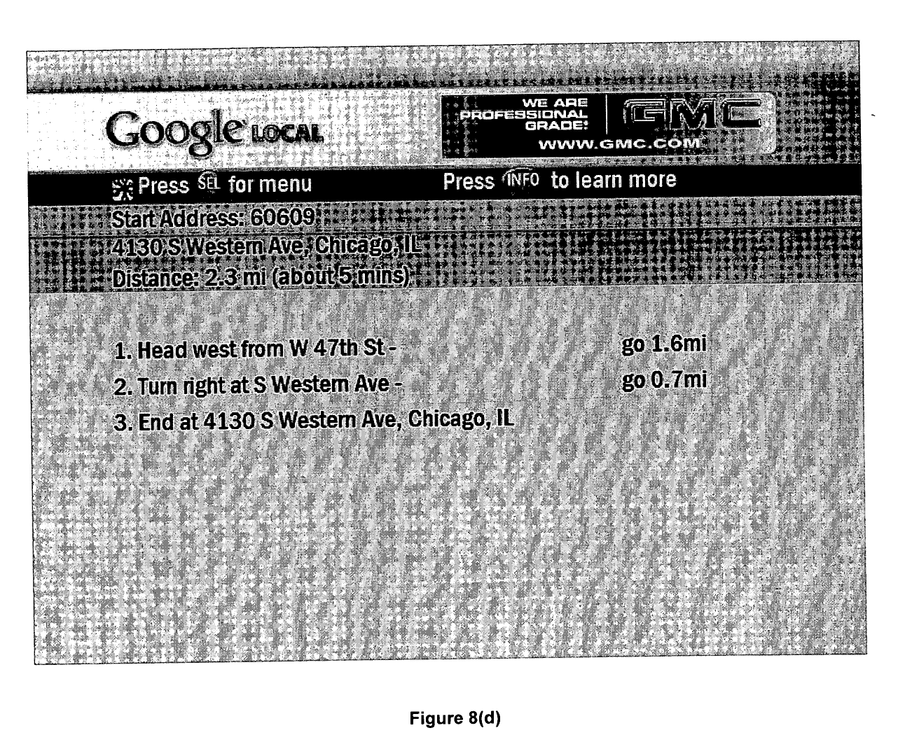

FIGS. 8(a)-8(d) are screenshots relating to a Google™ Local search. Thus, FIG. 8(a) illustrates a screen that allows a user to search in Google™ Local for a business in a particular location (e.g., in a particular zip code). FIG. 8(b) depicts a screen that displays the results of a search for businesses relating to “cars” located in zip code 60609. FIG. 8(c) depicts a screen that displays a street map that includes a business selected by the user. FIG. 8(d) depicts driving directs to the same business.

Other embodiments and uses of the invention will be apparent to those skilled in the art from consideration of the specification and practice of the invention disclosed herein. Although the invention has been particularly shown and described with reference to several preferred embodiments thereof, it will be understood by those skilled in the art that various changes in form and details may be made therein without departing from the spirit and scope of the invention as defined in the appended claims.

What is claimed is:

1. A method for interacting with internet applications via a cable television network, the method comprising the steps of:
executing an interactive application associated with an internet-based service;
generating a user interface for said interactive application for presentation on a display device;
receiving a user selection via said user interface;
transmitting a request over a broadband network to a centralized server coupled to said cable television network, wherein said request comprises information associated with said user selection;
receiving a reply over said cable television network to said request, wherein said reply comprises information associated with said internet-based service and in response to said request; and
processing said reply for display on said display device.

2. The method of claim 1, wherein said internet-based service is an online auction, an online store, or an information service.

3. The method of claim 1, wherein said broadband network is selected from the group consisting of: cable television network, satellite television network, IPTV network, cellular network, a digital subscriber line, and a combination thereof.

4. The method of claim 1, wherein said broadband network is a hybrid fiber-coax cable television network.

5. The method of claim 1, wherein said display device is a television.

6. The method of claim 1, wherein said request is transmitted on an upstream channel of said cable television network.

7. The method of claim 1, wherein said user selection is received from a remote control.

8. The method of claim 1, wherein said reply is received via a downstream channel of said cable television network.

9. The method of claim 1, wherein said reply is received as a dynamic in-band HTTP response.

10. The method of claim 1, wherein said reply is received as an out-of-band response.

11. The method of claim 1, wherein said Internet-based service is hosted by one or more servers accessible through the Internet.

12. The method of claim 1, wherein said broadband network is a cable television network.

13. The method of claim 1, wherein said step of generating a user interface is performed, at least in part, by a cable television set-top box.

14. The method of claim 1, wherein said display device is a television coupled to said cable television set-top box.

15. A method for interacting with Internet applications via a broadband network, the method comprising the steps of:
receiving a first request for information associated with an Internet-based service from an end user device coupled to a broadband network;
converting said first request into a second request, wherein said second request is directed to a server accessible through the Internet hosting said Internet-based service;
receiving a first reply from said server; and
converting said first reply into a second reply for transmission over said broadband network to said end user device.

16. The method of claim 15, wherein said first request comprises information associated with a user selection formulated through a user interface provided at said end user device.

17. The method of claim 15, wherein said first reply comprises information associated with said Internet-based service and in response to said second request.

18. The method of claim 15, wherein said first reply is received as a dynamic in-band HTTP response.

19. The method of claim 15, wherein said first reply is received as an out-of-band response.

20. The method of claim 15, wherein said Internet-based service is an online auction, online store, or an information service.

21. The method of claim 15, wherein said broadband network is selected from the group consisting of: cable television network, satellite television network, IPTV network, cellular network, a digital subscriber line, and a combination thereof.

22. The method of claim 15, wherein said broadband network is a hybrid fiber-coax cable television network.

23. The method of claim 15 wherein said steps of receiving are performed at a device coupled to said cable television network and said Internet.

24. The method of claim 15, wherein said first request is received on an upstream channel of said cable television network.

25. The method of claim 15, wherein said transmission occurs via a downstream channel of said cable television network.

26. The method of claim 15, wherein said end user device is a cable television set-top box.

27. A method for interacting with Internet applications via a broadband network, the method comprising the steps of:
executing an interactive application associated with an Internet-based service;
generating a user interface for said interactive application for display on a display device;
receiving a broadcast over said broadband network, wherein said broadcast comprises information made available by said Internet-based service; and
processing said broadcast for display on said display device.

28. The method of claim 27, further comprising the step of:
receiving one or more user preferences selected via said user interface; and wherein said step of processing comprises filtering said broadcast according to said one or more user preferences.

29. The method of claim 27, wherein said Internet-based service is a fantasy sports data providing service, a weather data providing service, or a financial data providing service.

30. The method of claim 27, wherein said broadband network is selected from the group consisting of: cable television network, satellite television network, IPTV network, cellular network, a digital subscriber line, and a combination thereof.

31. The method of claim 27, wherein said broadband network is a hybrid fiber-coax cable television network.

32. The method of claim 27, wherein said display device is a television.

33. The method of claim 27, wherein said broadcast is received via a downstream channel of said cable television network.

34. The method of claim 27, wherein said Internet-based service is hosted by one or more servers accessible through the Internet.

35. A method for interacting with Internet applications via a broadband network, the method comprising the steps of:
receiving first information made available by an Internet-based service at a server connected to the internet; and
converting said first information into second information to be broadcast over a broadband network to one or more end user devices;
wherein said broadband network is a digital television network and said one or more end user devices are digital television set-top boxes.

36. The method of claim 35, wherein said second information is received as a dynamic in-band HTTP response.

37. The method of claim 35, wherein said second information is received as an out-of-band response.

38. The method of claim 35, wherein said Internet-based service is a fantasy sports data providing service, a weather data providing service, or a financial data providing service.

39. A system comprising:
a server coupled to the Internet and coupled to a backend gateway of a broadband network; and
one or more end user devices coupled to said broadband network,
wherein said server acquires data made available by at least one source accessible through the Internet, and converts said data into a format for transmission over said broadband network by said backend gateway to said one or more end user devices.

40. The system of claim 39, wherein said source is an online store, an online auction facilitator, a fantasy sports data provider, a news source, a search engine, or an instant messaging source.

41. The system of claim 39, wherein said broadband network is selected from the group consisting of: a digital cable TV network, a digital satellite TV network, a digital cell phone network, a digital telephone network, and a combination thereof.

42. The system of claim 39, wherein said at least one of said one or more end user devices comprises a first component that is selected from the group consisting of: a digital cable TV set-top box, a digital satellite TV set-top box, an IPTV set-top box, a game console, a digital cell phone, a PDA, and a combination thereof.

43. A method comprising the steps of:
generating a user interface on an electronic input/output device;
executing Internet commerce via a television network on said electronic input/output device;
routing at least one Internet-based alert through said television network; and
displaying the at least one Internet-based alert on an electronic input/output device.

44. The method of claim 43, wherein said Internet commerce is an Internet-based auction.

45. The method of claim 43, wherein said Internet commerce is an Internet-based online retail transaction.

46. The method of claim 43, wherein the displaying of the Internet-based alert further comprise the step of displaying targeted, local advertising on said electronic input/output device.

47. The method of claim 43, wherein said step of executing Internet commerce comprises the step of tendering payment.

48. The method of claim 43, wherein said Internet-based alert is a spontaneous message or notification transmitted via the Internet network for display on a television.

49. The method of claim 43, wherein said Internet-based alert is an outbid notification for an online auction.

50. A method comprising the steps of:
generating a user interface at a digital television set-top box for an Internet auction;
displaying said user interface on a display coupled to said digital television set-top box;
placing an auction bid on said Internet auction using a remote-control coupled to said digital television set-top box;
routing at least one Internet-based alert through said digital television network; and
displaying the at least one Internet-based alert on a television set connected to said digital television set-top box.

51. The method of claim 50, wherein said remote control comprises up and down arrows to increase and decrease, respectively, the amount of said auction bid.

52. The method of claim 50, wherein said remote control comprises key mapped to pre-defined bid amounts.

53. The method of claim 50, further comprising the step of
providing auction feedback comments from a pre-defined list of frequently used comments mapped to keys on said remote-control.

54. The method of claim 50, further comprising the step of
providing auction feedback comments from a large, pre-defined list of standard comments selectable via up and down keys on said remote control.

55. The method of claim 50, further comprising the step of
providing payment and shipping information to said Internet auction after a successful purchase or auction bid.

56. A method comprising the steps of:
receiving an alert message from an Internet source;
translating said alert message to a standard format;
routing and transmitting said alert message to an end user device on a broadband network;
displaying said alert message on said end user device;
capturing a user response to said alert message; and
processing said user response.

57. The method of claim 56, wherein said end user device comprises a digital television set-top box.

58. The method of claim 56, wherein said step of processing comprises the step of:
executing an interactive application on said digital television set-top box, or
forwarding said user response back to said Internet source.

59. A computer-readable medium having computer-executable instructions for performing an interactive method with internet applications via a broadband network, the medium comprising:
a code segment that executes an interactive application associated with an internet-based service;
a code segment that generates a user interface for said interactive application for display on a display device;
a code segment that transmits a request over a broadband network to a centralized server coupled to said broadband network, wherein said request comprises information associated with said internet-based service; and
a code segment that processes and displays on a display device a reply over said broadband network to said request, wherein said reply comprises information associated with said internet-based service and in response to said request.

60. The computer-readable medium of claim 59, wherein said internet-based service is an online auction, an online store, or an information service.

61. The computer-readable medium of claim 59, wherein said broadband network is selected from the group consisting of: cable television network, satellite television network, IPTV network, cellular network, a digital subscriber line, and a combination thereof.

62. The computer-readable medium of claim 59, wherein said broadband network is a hybrid fiber-coax cable television network.

63. The computer-readable medium of claim 59, wherein said display device is a television.

64. The computer-readable medium of claim 59, wherein said request is transmitted on an upstream channel of said cable television network.

65. The computer-readable medium of claim 59, wherein said user selection is received from a remote control.

66. The computer-readable medium of claim 59, wherein said reply is received via a downstream channel of said cable television network.

67. The computer-readable medium of claim 59, wherein said Internet-based service is hosted by one or more servers accessible through the Internet.

68. The computer-readable medium of claim 59, wherein said broadband network is a cable television network.

69. The computer-readable medium of claim 59, wherein said step of generating a user interface is performed, at least in part, by a cable television set-top box.

70. The computer-readable medium of claim 59, wherein said display device is a television coupled to said cable television set-top box.
